(19) United States
(12) Patent Application Publication
(10) Pub. No.: US 2004/0047571 A1
(43) Pub. Date: Mar. 11, 2004

(54) Hermetically sealed ferrule

(76) Inventors: Warren Timothy Boord, Brooklyn Park, MN (US); Terry Vanderwert, Inver Grove Heights, MN (US)

Correspondence Address: MERCHANT & GOULD PC, P.O. BOX 2903, MINNEAPOLIS, MN, 55402-0903, US

(21) Appl. No.: 10/237,250

(22) Filed: Sep. 6, 2002

(51) Int. Cl. G02B 6/00

(52) U.S. Cl. 385/94; 385/138

(57) ABSTRACT

A hermetically sealed ferrule includes one or more walls cooperating to enclose a volume. At least one of the walls defines an orifice permitting passage to the enclosed volume. A fiber optic ribbon passes through the orifice to the enclosed volume. The fiber optic ribbon includes a plurality of optical fibers with a protective coating surrounding each of the optical fibers. Each optical fiber is exposed where it passes through the orifice. A low-temperature melting point glass seals a space between the exposed optical fibers and the region of the wall defining the orifice. A first epoxy layer extends between the fiber optic ribbon, an outer surface of the region of the wall defining the orifice, and the low-temperature melting point glass. A second epoxy layer extends between the fiber optic ribbon, an inner surface of the region of the wall defining the orifice, and the low-temperature melting point glass.

### FIELD OF THE INVENTION

The invention relates generally to optical networking equipment and components, and more particularly to a hermetically sealed ferrule for permitting access to optical components within a housing.

### BACKGROUND OF THE INVENTION

Optical networking equipment utilizes passive components, such as prisms, diffraction gratings, and lenses. The passive components are used for precise separation, combination, bending, and focusing of light waves that carry data through the network. It is important for the passive components to have known shapes and chemical compositions, in order for them to operate as desired. For example, a prism operates based upon the principle of dispersion (the principle of dispersion explains the reason why light of different frequencies “bends” different amounts when traveling through a prism). The “bend” exhibited by light of a given frequency is a function of, among other variables, the angle at which the light strikes the surface of the prism and the refractive index of the prism. If, for example, a prism that is epoxy mounted to a metal holder were to be subjected to a humid atmosphere, the epoxy could absorb water and expand, causing the prism to move and thus alter the angle at which the light strikes the prism. Further, the water may weaken the adhesive strength of the epoxy, making the device performance less reliable when exposed to mechanical vibrations or shock. The prism would cease to predictably bend the various frequencies of light, and the optical circuit in which the prism was embedded would either cease to function or would function inefficiently.

Heretofore, the components of optical networking devices have been contained within a housing that serves to minimize the deleterious effects of environmental factors upon the components it houses. However, optical fibers, which carry the light that propagates through an optical network, must enter and exit the housing. Over time, environmental factors, such as humidity or particulate contaminants, migrate to the interior of the housing through the passageway intended to permit entry and exit of the optical fibers. As described above, this phenomenon has an effect that is inimical to proper functioning of the components housed therein. Consequently, over time, network devices have a tendency to deteriorate.

As is evident from the preceding discussion, there exists a need for a way to permit optical fibers to enter and exit a housing without allowing environmental factors to enter the interior of the housing. A desirable scheme will be easily integrated into manufacturing processes, and will be relatively inexpensive.

### SUMMARY OF THE INVENTION

Against this backdrop the present invention has been developed. A hermetically sealed ferrule may include a set of one or more walls cooperating to enclose a volume. At least one of the walls has a region defining an orifice permitting passage to the enclosed volume. A fiber optic ribbon passes through the orifice to the enclosed volume. The fiber optic ribbon includes a plurality of optical fibers with a protective coating surrounding each of the optical fibers. Each optical fiber is exposed where it passes through the orifice. A low-temperature melting point glass seals a space between the exposed optical fibers and the region of the wall defining the orifice. A first epoxy layer extends between the fiber optic ribbon, an outer surface of the region of the wall defining the orifice, and the low-temperature melting point glass. Additionally, a second epoxy layer extends between the fiber optic ribbon, an inner surface of the region of the wall defining the orifice, and the low-temperature melting point glass.

According to another embodiment of the invention, a hermetically sealed ferrule may include a set of one or more walls cooperating to enclose a volume. At least one of the walls has a region defining a first and second orifice permitting passage to the enclosed volume. A first fiber optic ribbon passes through the first orifice to the enclosed volume. The first fiber optic ribbon includes a plurality of optical fibers with a protective coating surrounding each of the optical fibers. Each optical fiber is exposed where it passes through the orifice. A second fiber optic ribbon passes through the second orifice to the enclosed volume. The second fiber optic ribbon also includes a plurality of optical fibers with a protective coating surrounding each of the optical fibers. Each optical fiber is exposed where it passes through the orifice. A low-temperature melting point glass seals a space between the exposed optical fibers of the first optical fiber ribbon and the region of the wall defining the first orifice. A low-temperature melting point glass also seals a space between the exposed optical fibers of the second optical fiber ribbon and the region of the wall defining the second orifice. A first epoxy layer extends between the first fiber optic ribbon, an outer surface of the region of the wall defining the first orifice, and the low-temperature melting point glass. A second epoxy layer extends between the second fiber optic ribbon, an outer surface of the region of the wall defining the second orifice, and the low-temperature melting point glass. A third epoxy layer extends between the first fiber optic ribbon, an inner surface of the region of the wall defining the first orifice, and the low-temperature melting point glass. A fourth epoxy layer extends between the second fiber optic ribbon, an inner surface of the region of the wall defining the second orifice, and the low-temperature melting point glass.

These and various other features as well as advantages which characterize the present invention will be apparent from a reading of the following detailed description and a review of the associated drawings.

### BRIEF DESCRIPTION OF THE FIGURES

FIG. 1 depicts an optical networking device, in accordance with one embodiment of the present invention.

FIG. 2 depicts an optical fiber ribbon.

FIG. 3 depicts an embodiment of an orifice formed in a housing, wherein an optical ribbon is passed through the orifice, and the orifice is hermetically sealed.

FIG. 4 depicts the structure of FIG. 3 with an elongated ring added thereto, in accordance with one embodiment of the present invention.

FIG. 5 depicts the structure of FIG. 4 with a sheath fitted over the elongated ring, in accordance with one embodiment of the present invention.

FIG. 6 depicts a housing with multiple hermetically sealed orifices, in accordance with one embodiment of the present invention.

### DETAILED DESCRIPTION OF THE INVENTION

The components within a housing may be shielded from the influences of environmental factors by implementation of the following scheme. First, a fiber optic ribbon is extended through a passageway of a housing. Then, the passageway is hermetically sealed, so that it is not possible for environmental factors to enter by way of the passageway.

Before the fiber optic ribbon is passed through the passageway, its protective coating is removed from a portion of the ribbon, thereby exposing each of the glass optical fibers contained in the ribbon. The exposed portion of the ribbon is then passed through the passageway, and a low-melting point glass is melted between the exposed optical fiber and the walls of the housing. The low-melting point glass creates a barrier that environmental factors cannot pass.

Around the low-melting point glass, a mass of epoxy may be disposed. The epoxy lends rigidity to the joint created by the low-melting point glass and the glass in the exposed optical fiber. Optionally, an elongated ring may be attached to the outside of the housing, surrounding the passageway. The fiber optic ribbon passes through the elongated ring and extends through the passageway, thereby reaching the interior of the housing. The interior space of the elongated ring not occupied by the optical ribbon or the first epoxy layer may be filled with a second layer of epoxy.

Finally, a rubber sheath may be slipped over the elongated ring and may extend along a length of the fiber optic ribbon. The rubber sheath prevents the optical ribbon from making small-diameter bends, and therefore prevents the optical fibers contained therein from breaking. The interior space of the rubber sheath not occupied by the optical ribbon may be filled by a room temperature vulcanized silicon, to enhance rigidity and to adhere the rubber sheath to the optical ribbon.

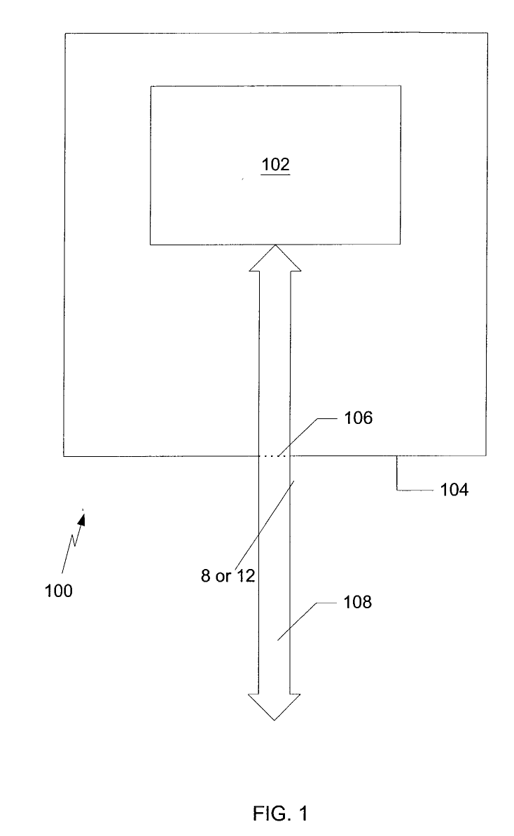

The above-summarized description is expounded upon in the following disclosure by reference to FIGS. 1-6. Certain variants are described herein, including variants that permit more than one optical ribbon to enter and/or exit the housing.

FIG. 1 depicts an optical networking device 100. As can be seen from FIG. 1, the optical networking device 100 includes optical components 102 housed within a housing 104. Examples of optical components 102 are prisms, lenses, diffraction gratings, fan-out circuits, polarization management components, etc. The optical components 102 cooperate to perform a task useful in the context of optical networking. For example, the optical components 102 may multiplex or demultiplex incoming or outgoing optical signals. Additionally, the optical components 102 may take part in adding or dropping an optical signal from a local network (not depicted).

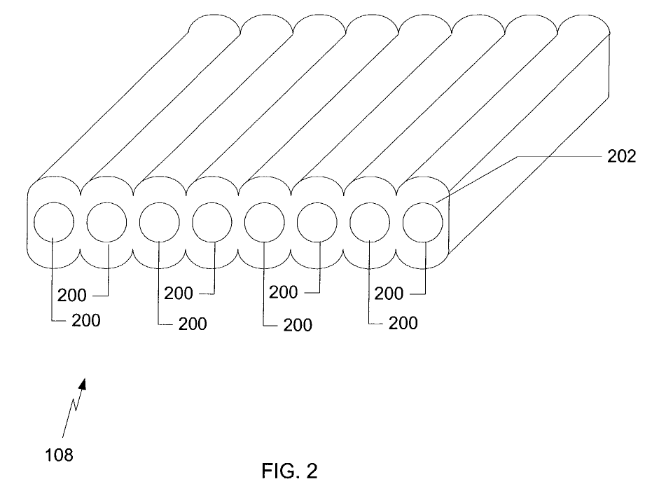

Optical signals are carried to the optical components 102 via an optical ribbon 108. As depicted in FIG. 2, the optical ribbon 108 includes several individual optical fibers 200, each of which is housed within a protective coating 202. In principle, an optical ribbon 108 may contain any number of optical fibers 200. In practice, optical ribbons 108 typically contain eight or twelve optical fibers 200.

Returning to FIG. 1, it can be seen that the optical ribbon 108 enters/exits the housing 104 through a passageway (also referred to herein as an “orifice”) 106. The passageway 106 may take on several different shapes (e.g., a slot), depending upon the shape of the optical ribbon 108 to be passed through the orifice 106.

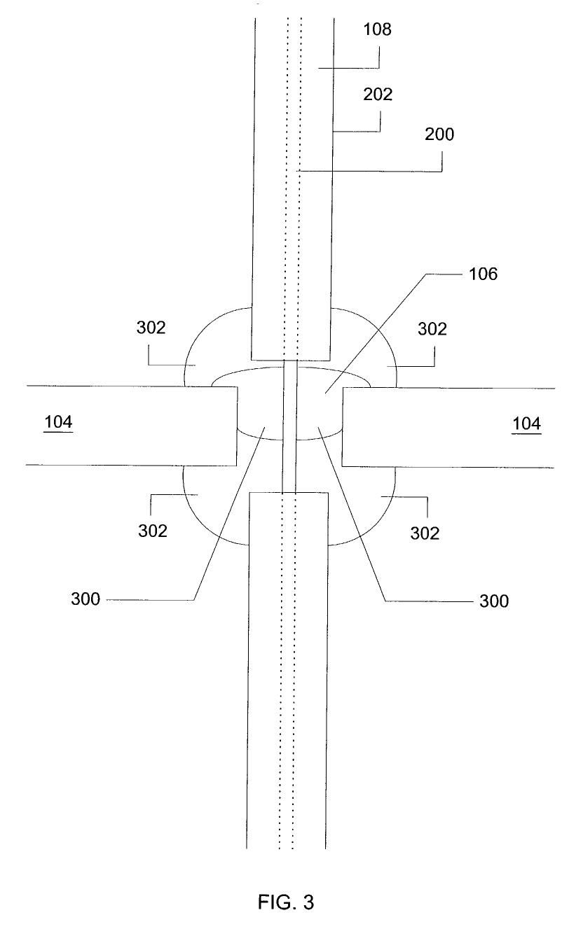

FIG. 3 depicts an enlarged cross-sectional view of the housing 104 and orifice 106 referred to in FIG. 1. As can be seen from FIG. 3, an optical ribbon 108 passes through the orifice 106. Where the optical ribbon 108 passes through the orifice 106, its protective coating 202 has been stripped away, revealing each of the optical fibers 200 contained therein. Many methods are available for removing the protective coating 202 of the optical ribbon 108. For example, the portion of the protective coating 202 to be removed may be heated using a heat stripper, thereby melting the protective coating 202. Thereafter, the melted portion may be immersed in a methylene chloride bath, so as to eat away the melted portion. An advantage of this technique is that the portion of the protective coating 202 that is removed can be carefully controlled. Other methods of removing the protective coating 202 are known in the art and are within the scope of this application.

A low-melting point glass 300 is used to hermetically seal the area between the exposed optical fibers 200 and the portion of the wall 104 forming the orifice 106. The low melting-point glass 300 may have a melting point below 400° C. It is applied by placing beads of the low-melting point glass in the area of the orifice 106 and then heating the beads to their melting point. The beads respond by melting and forming a seal between the wall 104 and the optical fibers 200. An example of a low-melting point glass is DM2700, available from Diemat, Inc.

As is evident from FIG. 3, the protective coating 202 does not pass from one side of the wall 104 to the other. One reason for this design choice is that the protective coating 202 is water permeable to some extent. Thus, if the protective coating 202 were to be left in place, water could be carried into the interior of the housing 104 by way of migration through the protective coating 108. However, glass (such as the glass comprising the optical fiber 200 or the low-temperature melting point glass 300) is not permeable by either water or other contaminants. In fact, the barrier created by the optical fiber 200 and the low-temperature melting point glass 300 is hermetic, allowing less than 1*10⁻⁸ cubic centimeters per second of helium to pass through.

A first layer of epoxy 302 may surround the low-melting point glass 300. The epoxy 302 may join the low-melting point glass 300, the optical ribbon 108, and either the interior or exterior surface of the wall 104. One advantage of the epoxy layer 302 is that it lends rigidity to the joint formed by the optical fiber 200 and the low-temperature melting point glass 300. Thus, during subsequent manufacturing stages, the joint is less likely to become damaged. Additionally, the exposed optical fibers 200 are less likely to become damaged. The epoxy layer 302 may be composed of an ultraviolet curable epoxy. Such an epoxy may be cured by exposure to ultraviolet radiation for as little as approximately one minute.

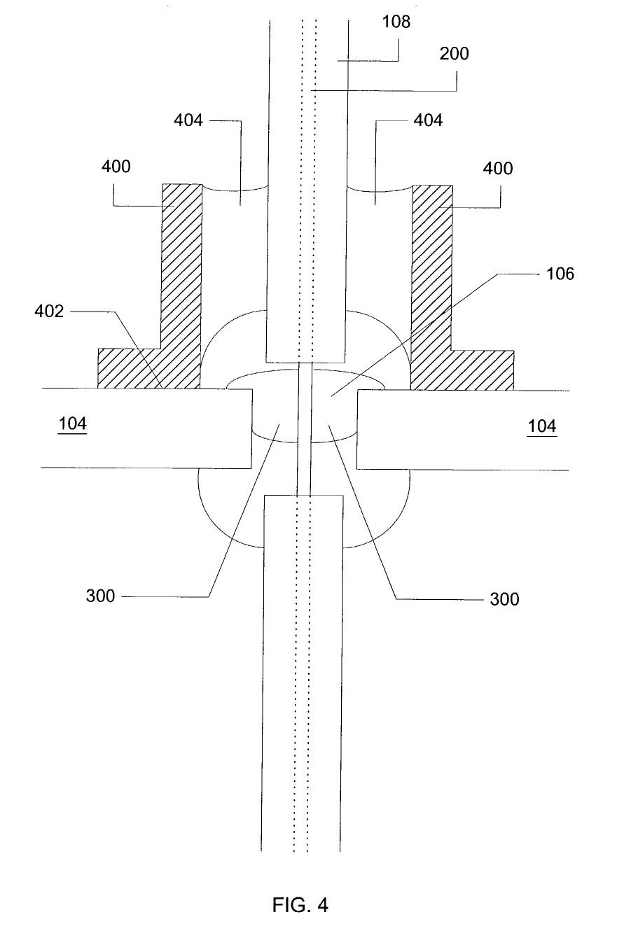

FIG. 4 depicts an enlarged cross-sectional view of the joint described with reference to FIG. 3. As can be seen from FIG. 4, an elongated ring 400 surrounds the orifice 106, attached to the outer surface of the wall 104. The elongated ring 400 may have an enlarged surface 402, permitting reliable attachment of the ring 400 to the outer surface of the wall 104. The ring 400 extends along a length of the optical ribbon 108, with the ribbon 108 passing through the interior region of the ring 400, through the orifice 106, and into the interior of the housing 104.

The interior region of the ring 400 is filled with a layer of epoxy 404. The epoxy 404 serves to add additional rigidity to the structure and to adhere the optical ribbon 108 to the ring 400. The epoxy layer 404 may or may not be of the same form as that used to encapsulate the low-melting point glass 300. One advantage of the elongated ring 400 is that it prevents bending of the optical ribbon 108 at the point at which its optical fibers 200 are exposed.

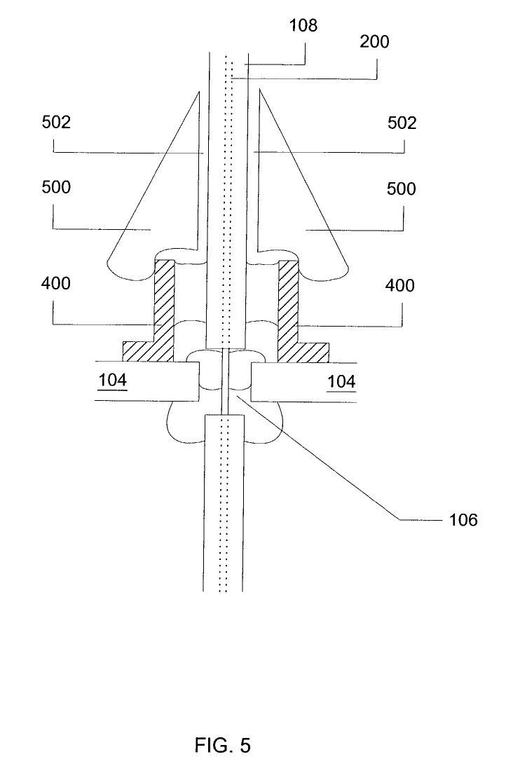

FIG. 5 depicts an enlarged cross-sectional view of the joint and ring described with reference to FIG. 4. As shown in FIG. 5, an optional sheath 500 is fitted over the elongated ring 400, extending along a length of the optical ribbon 108. The sheath 500 may be made of rubber or another suitable material. The ribbon 108 passes through the interior of the sheath 500, through the elongated ring 400, through the orifice 106, and into the interior of the housing 104. The sheath 500 may be shaped so as to fit over the ring 400, and thereafter taper inwardly toward the ribbon 108. This shape permits relatively little flexibility at the base of the sheath (where the sheath is relatively thick), and progressively more flexibility as the sheath 500 tapers inwardly toward the ribbon 108.

The interior region of the rubber sheath 500 may be filled with a room temperature vulcanized silicone 502. The room temperature vulcanized silicone 502 lends additional rigidity to the sheath structure 500, and serves to adhere the sheath 500 to the ribbon 108. One advantage of the sheath 500 is that it prevents the optical ribbon 108 from making a small-diameter bend at the point where the ribbon 108 exits/enters the ring 400, meaning that the optical fibers 200 contained therein are further protected from damage due to bending.

Optionally, the elongated ring 400 may contain an outwardly protruding lip (not depicted). The sheath 500 may fit over the outwardly protruding lip, thereby further securing the sheath 500 to the ring 400.

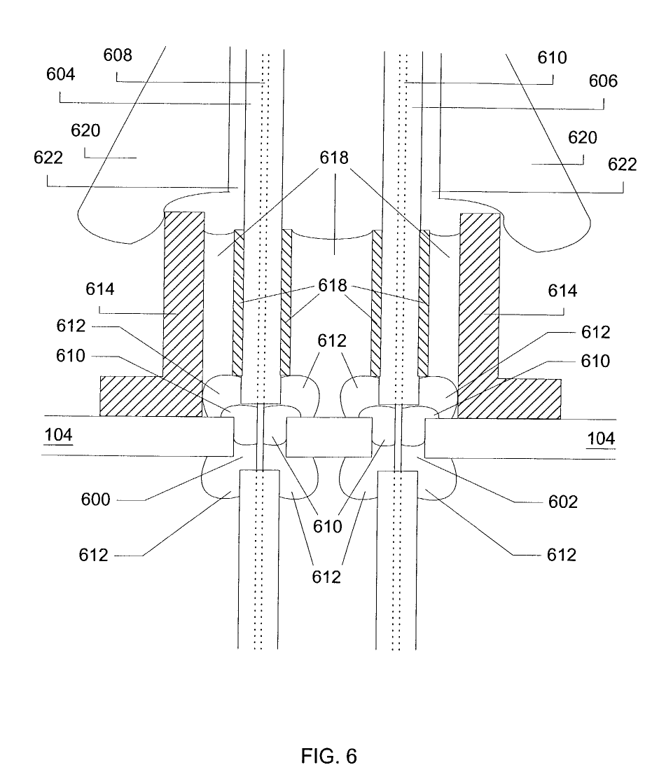

FIG. 6 depicts a ferrule permitting multiple optical ribbons to enter and exit the housing. As can be seen from FIG. 6, the housing 104 may contain first and second orifices 600 and 602. Each orifice 600 and 602 permits an optical ribbon 604 and 606 to pass into the interior of the housing 104. As shown in FIG. 6, the orifices 600 and 602 are juxtaposed.

As was the case with the embodiments shown in FIGS. 1-5, each optical ribbon 604 and 606 contains optical fibers 608 and 610, which are exposed where they pass through the orifices 600 and 602. A low-melting point glass 610 is melted between the exposed fibers 608 and 610 and the housing 104. A layer of epoxy 612 is disposed over the low-melting point glass 612, so as to reinforce the joint created by the low-melting point glass 610 and the exposed optical fibers 608 and 610. An elongated ring 614 is attached to the outer surface of the housing 104, surrounding both orifices 600 and 602. The elongated ring 614 extends along a length of the optical ribbons 604 and 606, with the optical ribbons 604 and 606 passing through the interior region of the ring 614. The interior region of the ring is filled with an epoxy layer 616. The epoxy layer 616 lends rigidity to the structure and adheres the ring to the optical ribbons 604 and 606.

As illustrated in FIG. 6, silicon wafers 618 may be inserted in the interior of the ring 614. The silicon wafers 618 may be situated on either side of the optical ribbons 604 and 606, so as to support the ribbons and prevent them from bending or twisting. Another advantage of the wafers 618 is that they occupy space in the interior of the ring 614 that would otherwise be filled by the epoxy layer 616. Epoxy 616 tends to shrink as it sets. Consequently, stress is imparted to the ribbons 604 and 606, damaging the optical fibers 608 and 610 contained therein. By reducing the amount epoxy housed in the interior of the ring 614, the hostile effects of epoxy shrinkage are attenuated.

A sheath 620 may be fitted over the elongated ring 614, extending along a length of the optical ribbons 604 and 606. The sheath 620 may be made of rubber or another suitable material. The sheath 620 may be shaped so as to fit over the ring 614, and thereafter tape inwardly toward the ribbons 604 and 606. This shape permits relatively little flexibility at the base of the sheath (where the sheath is relatively thick), and progressively more flexibility as the sheath 620 tapers inwardly toward the ribbons 604 and 606.

The interior region of the sheath 620 may be filled with a room temperature vulcanized silicone 622. The room temperature vulcanized silicone 622 lends additional rigidity to the sheath structure 620, and serves to adhere the sheath 620 to the ribbons 604 and 606.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, other forms of materials having properties known to be similar to the materials disclosed herein may be used. Additionally, the orifices may take on shapes other than slots (the orifices may be circular, for example). Still further, if the housing contains numerous orifices, the orifices need not be in proximity to one another, and need not be encircled by a single elongated ring. Numerous other changes may be made which will readily suggest themselves to those skilled in the art and which are encompassed in the invention disclosed and as defined in the appended claims.

The claimed invention is:

1. A hermetically sealed ferrule, comprising:
a set of one or more walls cooperating to enclose a volume, at least one of the walls having a region defining an orifice permitting passage to the enclosed volume;
a fiber optic ribbon passing through the orifice to the enclosed volume, the fiber optic ribbon comprising a plurality of optical fibers with a protective coating surrounding each of the optical fibers, wherein each optical fiber is exposed as it passes through the orifice;
a low-temperature melting point glass sealing a space between the exposed optical fibers and the region of the wall defining the orifice;
a first epoxy layer extending between the fiber optic ribbon, an outer surface of the region of the wall defining the orifice, and the low-temperature melting point glass; and
a second epoxy layer extending between the fiber optic ribbon, an inner surface of the region of the wall defining the orifice, and the low-temperature melting point glass.

2. The ferrule of claim 1, wherein the low-temperature melting point glass has a melting point of less than 400° C.

3. The ferrule of claim 1, wherein the first and second epoxy layers comprise an ultraviolet cured epoxy.

4. The ferrule of claim 1, further comprising:
an elongated ring surrounding the orifice and joined to the outer surface of the region of the wall defining the orifice; and
a third layer of epoxy filling a space between the ring and the optical fiber.

5. The ferrule of claim 4, further comprising:
a rubber sheath extending over a portion of the elongated ring, and extending along a length of the fiber ribbon, so as to prevent the optical fibers within the fiber ribbon from breaking when the ribbon is bent.

6. The ferrule of claim 5, further comprising:
a layer of room temperature vulcanizing silicone adhering the rubber sheath to fiber ribbon.

7. The ferrule of claim 5, wherein the elongated ring defines a lip on its outer surface, and wherein the rubber sheath extends over the lip.

8. The ferrule of claim 1, wherein an optical device selected from a set of optical devices consisting of a prism, a lens, a diffraction grating, polarization management components, and a fan-out circuit is housed within the enclosed volume.

9. The ferrule of claim 1, wherein the orifice is shaped as a slot.

10. The ferrule of claim 1, wherein the fiber optic ribbon contains at least eight optical fibers.

11. The ferrule of claim 1, wherein the fiber optic ribbon contains at least twelve optical fibers.

12. The ferrule of claim 5, wherein a silicon wafer is disposed along one side of the optical fiber ribbon, and is housed within the rubber sheath.

13. The ferrule of claim 12, wherein two or more silicon wafers are disposed along two sides of the optical fiber ribbon, and are housed within the rubber sheath.

14. A hermetically sealed ferrule, comprising:
a set of one or more walls cooperating to enclose a volume, at least one of the walls having a region defining a first and second orifice permitting passage to the enclosed volume;
a first fiber optic ribbon passing through the first orifice to the enclosed volume, the first fiber optic ribbon comprising a plurality of optical fibers with a protective coating surrounding each of the optical fibers, wherein each optical fiber is exposed as it passes through the orifice;
a second fiber optic ribbon passing through the second orifice to the enclosed volume, the second fiber optic ribbon comprising a plurality of optical fibers with a protective coating surrounding each of the optical fibers, wherein each optical fiber is exposed as it passes through the orifice;
a low-temperature melting point glass sealing a space between the exposed optical fibers of the first optical fiber ribbon and the region of the wall defining the first orifice;
a low-temperature melting point glass sealing a space between the exposed optical fibers of the second optical fiber ribbon and the region of the wall defining the second orifice;
a first epoxy layer extending between the first fiber optic ribbon, an outer surface of the region of the wall defining the first orifice, and the low-temperature melting point glass;
a second epoxy layer extending between the second fiber optic ribbon, an outer surface of the region of the wall defining the second orifice, and the low-temperature melting point glass;
a third epoxy layer extending between the first fiber optic ribbon, an inner surface of the region of the wall defining the first orifice, and the low-temperature melting point glass; and
a fourth epoxy layer extending between the second fiber optic ribbon, an inner surface of the region of the wall defining the second orifice, and the low-temperature melting point glass.

15. The ferrule of claim 14, wherein the low-temperature melting point glass has a melting point of less than 400° C.

16. The ferrule of claim 14, wherein the first, second, third and fourth epoxy layers comprise an ultraviolet cured epoxy.

17. The ferrule of claim 14, further comprising:
an elongated ring surrounding the first and second orifices and joined to the outer surface of the region of the wall defining the first and second orifices; and
a fifth layer of epoxy filling a space between the ring and the first and second optical fibers.

18. The ferrule of claim 17, further comprising:
a rubber sheath extending over a portion of the elongated ring, and extending along a length of the first and second fiber ribbons, so as to prevent the optical fibers within the first and second fiber ribbons from breaking when the ribbons are bent.

19. The ferrule of claim 18, further comprising:
a layer of room temperature vulcanizing silicone adhering the rubber sheath to first and second fiber ribbons.

20. The ferrule of claim 18, wherein the elongated ring defines a lip on its outer surface, and wherein the rubber sheath extends over the lip.

21. The ferrule of claim 14, wherein an optical device selected from a set of optical devices consisting of a prism, a lens, a diffraction grating, polarization management components, and a fan-out circuit is housed within the enclosed volume.

22. The ferrule of claim 14, wherein the first and second orifices are shaped as a slot.

23. The ferrule of claim 14, wherein the fiber optic ribbon contains at least eight optical fibers.

24. The ferrule of claim 14, wherein the fiber optic ribbon contains at least twelve optical fibers.

25. The ferrule of claim 18, wherein silicon wafers are disposed along one side of the each of the first and second optical fiber ribbons, and are housed within the rubber sheath.

26. The ferrule of claim 25, wherein two or more silicon wafers are disposed along two sides of each of the first and second optical fiber ribbons, and are housed within the rubber sheath.
